(19) United States
(12) Patent Application Publication
(10) Pub. No.: US 2026/0158956 A1
(43) Pub. Date: Jun. 11, 2026

(54) MANAGEMENT OF CHARGING STATION ALLIANCE AND OPTIMIZATION SYSTEM FOR CHARGING STATION LAYOUT

(71) Applicant: SHANGHAI JIAO TONG UNIVERSITY, Shanghai (CN)

(72) Inventors: Donghan FENG, Shanghai (CN); Zeyu LIU, Shanghai (CN); Yun ZHOU, Shanghai (CN); Yuanhao FENG, Shanghai (CN); Wenhang YIN, Shanghai (CN); Yin YI, Shanghai (CN); Qiyuan LIU, Shanghai (CN); Shuhe ZHAN, Shanghai (CN)

(21) Appl. No.: 19/066,926

(22) Filed: Feb. 28, 2025

Related U.S. Application Data
(63) Continuation of application No. PCT/CN2024/100306, filed on Jun. 20, 2024.

(30) Foreign Application Priority Data
Mar. 29, 2024 (CN) 202410379909.6

(51) Int. Cl. B60L 53/64; B60L 53/68; G06Q 30/0201

(52) U.S. Cl. CPC B60L 53/64; B60L 53/68; G06Q 30/0206

(57) ABSTRACT

A charging station layout optimization system of the Charging Station Alliance comprises information collection module to collect information on electric vehicles and charging stations; information processing module for receiving and processing information; storage module for storing information; pricing decision module for implementing charging pricing for each charging station in the system, supporting its charging and charging; learning and optimization module to continuously learn information and pricing decisions of users, alliance members, charging stations, and charging piles and optimizes pricing and services of system; communication module for establishing real-time communication of system, obtaining electronic maps, and forming charging station map; and optimization module for the layout of charging stations based on optimization suggestions by the communication module and discussion conclusions to provide optimization plans for increase or decrease of members of alliance, charging stations, charging piles, performance requirements, and upgrades of charging piles.

### CROSS-REFERENCE TO RELATED APPLICATIONS

The subject application is a continuation of PCT/CN2024/100306 filed on Jun. 20, 2024, which in turn claims priority on Chinese Patent Application No. CN202410379909.6 filed on Mar. 29, 2024 in China. The contents and subject matters of the PCT international stage application and the Chinese priority application are incorporated herein by reference.

### TECHNICAL FIELD

This application relates to electric vehicle charging, particularly to a management system for a charging station alliance for electric vehicle charging and a charging station layout optimization system for a charging station alliance.

### BACKGROUND ART

In recent years, the advantages of electric vehicles (EVs) have led to rapid increase in their number, prompting researchers to be optimistic about their future growth. However, the surge in the use of electric vehicles has also led to fierce competition and intensified supply-demand contradiction in charging facilities. In China, as shown in FIG. 2, as of October 2023, approximately 65.5% of public charging stations are controlled by the top 5 charging service providers (CSPs).

The concentration of charging infrastructure has led to intensified competition among a limited number of fee based service providers. Obviously, from the perspective of maximizing profits, charging stations (CSs) under the same charging service provider naturally form charging station alliances (CSAs), cooperate internally, and compete with other charging station alliances to maximize overall profits. Besides geographical location, pricing is the most effective way for charging stations to attract electric vehicles.

Recently, the dynamic pricing strategy of charging stations has received increasing research and exploration. Although there are currently no widely adopted commercial examples of dynamic pricing in China, similar innovative explorations have been encouraged by government policies. The document “Guiding Opinions of the General Office of the State Council on Further Building a High Quality Charging Infrastructure System” issued by the State Council in June 2023 emphasizes “encouraging the development of new technologies, new formats, and new models” and “strengthening technological research such as information sharing and unified settlement systems.”

Improving the service quality of charging stations, rationalizing charging pricing, and optimizing the layout of charging stations have become urgent challenges that need to be addressed.

### SUMMARY OF THE INVENTION

The present invention provides a charging station alliance management system for electric vehicle charging, installed on a computer or mobile phone, to establish customer service interaction, alliance member interaction, rationalize charging pricing, and gradually optimize charging station layout for the charging station alliance.

In order to solve the above technical problems, according to one aspect of the present invention, a charging station layout optimization system for a charging station alliance is provided, which comprises an information collection module that collects user's electric vehicle information, user's charging request information, member information of the charging station alliance, charging station information, and charging pile information; the information processing module is connected to the information collection module for communication, receiving and processing various information collected by the information collection module, and providing feedback to the administrator for improvement and processing of incomplete or unprocessed information; a storage module that communicates with the information processing module and stores various information processed by the information processing module; the pricing decision module is connected to the information processing module and/or storage module for communication. Based on the charging price list provided by the members of the charging station alliance, it sets a charging price for each charging station, technically supports the charging station to implement charging and charge according to the pricing, and transmits the pricing results to the storage module for storage; the learning and optimization module is connected to the storage module for communication, continuously learning various information about users, members of the charging station alliance, charging stations, and charging piles, as well as the pricing results of the pricing decision module. Based on feedback from users, members of the charging station alliance, charging stations, and charging piles, the module optimizes the pricing and services of each member of the charging station alliance, their charging stations, and charging piles in the system; the communication module is connected to the storage module for communication, and an interaction module is established among members of the electric vehicle charging alliance to discuss user needs, changes in electric vehicle battery performance, and optimization suggestions provided by the learning and optimization module; and the layout optimization module, based on the optimization suggestions provided by the communication module, discusses the conclusions and provides optimization solutions for the addition or removal of members of the charging station alliance, the addition or removal of charging stations, the addition or removal of charging piles, the performance requirements and upgrading of charging piles. The performance requirements and optimization plans for upgrading and replacing charging stations comprise requirements for charging rate, charging time, and charging environment; and the optimization scheme provided by the layout optimization module comprises an evaluation report based on the charging station layout scheme requested by the members of the charging station alliance.

According to the embodiments of the present invention, the charging station layout optimization system of the charging station alliance may further comprise a charging status monitoring module for monitoring and reporting the queuing status of each charging station. The information processing module predicts the possible queuing time of users based on the queuing status information provided by the charging status monitoring module and displays it on the client.

According to the embodiments of the present invention, the charging station layout optimization system of the charging station alliance may further comprise a surrounding road monitoring module, which communicates with the road monitoring of the electronic map to obtain the road conditions and vehicle congestion level around each charging station, and reports the average driving speed of a certain road section and the time required for the customer to arrive at the charging station according to the customer's request.

According to the embodiments of the present invention, the charging station layout optimization system of the charging station alliance may further comprise a cost budgeting module, which calculates and provides the cost of electric vehicle charging based on the information provided by the user on the interactive communication module, comprising the cost of driving, queuing and waiting, charging time, charging electricity cost, and charging site usage cost.

According to the embodiments of the present invention, the charging station layout optimization system of the charging station alliance may further comprise an opinion feedback module, which is connected in communication with the charging station alliance management system and transmits the customer feedback and suggestions obtained by the opinion feedback module to the information collection module of the charging station alliance management system. After processing by the information processing module, they are stored in the storage module of the charging station alliance management system and further optimized by the learning and optimization module.

According to the embodiments of the present invention, the storage module may comprise storage or cloud storage.

According to the embodiments of the present invention, the pricing decision module may comprise modeling the price factors that affect the charging station alliance, providing a dynamic pricing strategy, and using a two-stage evolutionary game to determine the optimal pricing decision for the charging station alliance in the expanding action space. The price factors that affect charging stations may comprise grid electricity prices, site costs, depreciation of charging piles, charging rates and utilization rates, competition in the same industry, and customer satisfaction. The charging pricing of all charging stations in any charging station belonging to the charging station alliance can be the same or different.

According to the embodiments of the present invention, the charging station layout optimization system of the charging station alliance may further comprise an inter member interaction module established among the members of the charging station alliance, which comprises text interaction, voice interaction, and video conferencing. After the layout optimization module provides optimization solutions for the addition or removal of members of the charging station alliance, the addition or removal of charging stations, the addition or removal of charging piles, the performance requirements and upgrading of charging piles, the members of the charging station alliance can make decisions on the optimization solutions through the interaction module among alliance members. The surrounding road monitoring module may have the function of collecting traffic conditions statistics of surrounding roads, and the layout optimization module will use the results of the surrounding road statistics of multiple adjacent charging stations collected by the surrounding road monitoring module as one of the optimization parameters to determine the increase or decrease of members of the charging station alliance, the increase or decrease of charging stations, the increase or decrease of charging piles, the performance requirements of charging piles, and the optimization plan for upgrading and replacement.

According to the embodiments of the present invention, when the charging status monitoring module detects that the number of electric vehicles waiting in line for charging reaches a predetermined threshold, the layout optimization module uses the number of electric vehicles waiting in line for charging detected by the charging status monitoring module as one of the optimization parameters to determine the increase or decrease of members of the charging station alliance, the increase or decrease of charging stations, the increase or decrease of charging piles, the performance requirements of charging piles, and the optimization plan for upgrading and replacing.

According to another aspect of the present invention, a management system for a charging station alliance is provided, comprising an information collection module that collects user's electric vehicle information, user's charging request information, member information of the charging station alliance, charging station information, and charging pile information; the information processing module is connected to the information collection module for communication, receiving and processing various information collected by the information collection module, and providing feedback to the administrator for improvement and processing of incomplete or unprocessed information; a storage module that communicates with the information processing module and stores various information processed by the information processing module; the pricing decision module is connected to the information processing module and/or storage module for communication. Based on the charging price list provided by the members of the charging station alliance, it implements charging pricing for each charging station, supports charging and charging according to the pricing, and transmits the pricing results to the storage module for storage; the learning and optimization module is connected to the storage module for communication, continuously learning various information about users, members of the charging station alliance, charging stations, and charging piles, as well as the pricing results of the pricing decision module. Based on feedback from users, members of the charging station alliance, charging stations, and charging piles, the module optimizes the pricing and services of each member of the charging station alliance, their charging stations, and charging piles in the system; the communication module is connected to the storage module and establishes a charging station alliance management system for real-time communication with electronic map providers, users, members of the charging station alliance, charging stations, and charging piles. It obtains the electronic map provided by the electronic map provider and loads each charging station on the electronic map to form a charging station map that comprises each charging station in the charging station alliance; the customer service interaction module displays a charging station map on the client, which comprises the distribution diagram of charging stations and the geographic coordinates of each charging station, the distance from the user to the charging station, charging price information, and notification information related to electric vehicle charging. This establishes interactive communication between the user and their selected charging station; and the optimization module for charging station layout, based on the optimization suggestions provided by the communication module, discuss the conclusions and provide optimization solutions for the addition or removal of members of the charging station alliance, the addition or removal of charging stations, the addition or removal of charging piles, the performance requirements and upgrading of charging piles. The performance requirements and optimization plans for upgrading and replacing charging stations comprise requirements for charging rate, charging time, and charging environment. The optimization scheme provided by the layout optimization module comprises an evaluation report based on the charging station layout scheme requested by members of the charging station alliance.

According to another aspect of the present invention, there is provided a management system for a charging station alliance for electric vehicle charging, comprising a charging station layout optimization system of the charging station alliance as described above.

Compared with existing technologies, the management of the charging station alliance and the optimization system for charging station layout according to the embodiments of the present invention can achieve at least the following beneficial effects:
1. Established a decision model for electric vehicles and charging stations, integrating the uncertainty caused by information asymmetry between electric vehicles and charging stations and the limited rationality of electric vehicle users. The standardized management of charging stations and reasonable pricing of charging are urgent problems that need to be solved in the market. In order to solve the pricing decision model, evolutionary game theory is used to describe the dynamic pricing game between charging station alliances, and the equilibrium provides the optimal pricing strategy.
2. The charging station alliance management system for electric vehicle charging according to the embodiments of the present invention can be used for current small-scale charging station alliances, as well as for future large-scale charging station alliances. The information collected through the information module from both the supply and demand ends will continue to increase, and one of the important means to solve the supply-demand imbalance is to reasonably layout the charging stations. With the continuous development and growth of the charging station alliance, under the incentive of negotiation and co construction, and within the framework of the charging station alliance management system for electric vehicle charging according to the embodiments of the present invention, the charging stations can be reasonably laid out through inter alliance interaction and negotiation.

### BRIEF DESCRIPTION OF THE DRAWINGS

In order to more clearly illustrate the technical solution of the embodiments of the present invention, a brief introduction is given to the accompanying drawings of the embodiments. It is obvious that the accompanying drawings described below only relate to some embodiments of the present invention, and do not limit the scope of protection for the present invention.

FIG. 1 is a block diagram showing a charging station alliance management system for electric vehicle charging according to an embodiment of the present invention.

FIG. 2 is a schematic diagram showing the number of charging stations owned by the top ten public charging station operators in China as of October 2023.

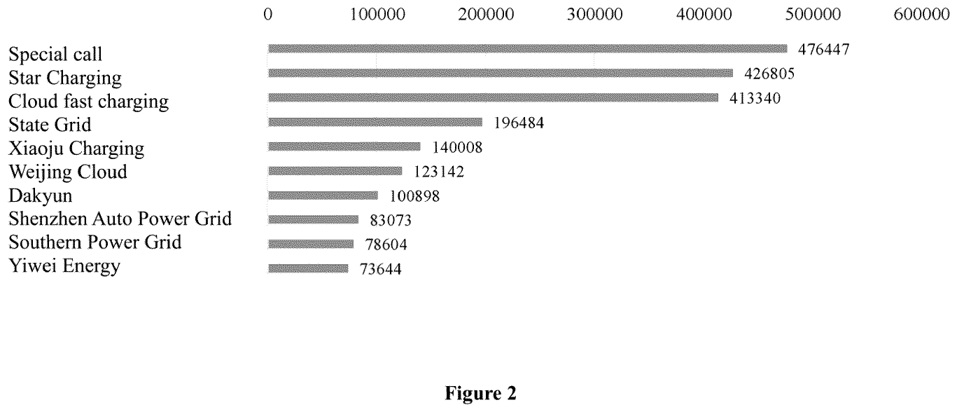

FIG. 3 is a schematic diagram showing the time series and information exchange relationship in the charging station alliance management system for electric vehicle charging according to an embodiment of the present invention.

FIG. 4 shows the shape of the value function, where risk aversion is reflected as, |v(x₀−x₁)|<|v(x₀+x₁|, The marginal effect is reflected as v(x₀+2x₁)<2v(x₀+x₁).

### DETAILED DESCRIPTION OF THE INVENTION

In order to clarify the purpose, technical solution, and advantages of the embodiments of the present invention, the following will provide a clear and complete description of the technical solution of the embodiments of the present invention in conjunction with the accompanying drawings. Obviously, the described embodiments are a part of the embodiments of the present invention, rather than the entire embodiments. Based on the described embodiments of the present invention, all other embodiments obtained by ordinary skilled persons in the art without the need for creative labor are within the scope of protection of the present invention.

Unless otherwise defined, the technical or scientific terms used herein shall have the usual meanings as understood by persons with general skills in the field to which this application belongs. The use of “first”, “second” and similar words in the specification and claims of this patent application does not indicate any order, quantity or importance, but is only used to distinguish different components. Similarly, words like “one” or “one” do not indicate a quantity limit but rather indicate the existence of at least one.

The following are several terms mentioned in this article:

Electric vehicles refer to rechargeable pure electric vehicles and hybrid electric vehicles. For ease of description, sometimes electric vehicles and users may have the same meaning; charging station refers to a device used to charge electric vehicles; charging station refers to a place where electric vehicles are charged, comprising one or more charging stations, and is responsible for their operation and management; a charging station alliance has multiple charging stations and operates and manages them uniformly. It should be noted that multiple charging station alliances can form larger alliances, also known as charging station alliances. Charging station alliances that join larger alliances are referred to as charging station alliance members, as long as they do not cause conceptual confusion.

Below, the embodiments of the present invention will be described in conjunction with the accompanying drawings.

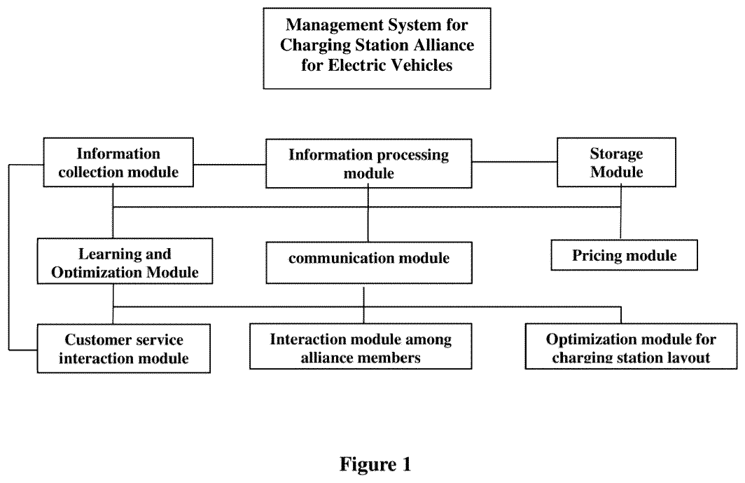

As shown in FIG. 1, the charging station alliance management system for electric vehicle charging according to the embodiment of the present invention comprises an information collection module, an information processing module, a storage module, a pricing decision module, a learning and optimization module, a communication module, a customer service interaction module, an alliance member interaction module, a charging station layout optimization module, etc. Below, the above modules are described separately.

The information collection module in the present invention collects user information on electric vehicles, charging requests, members of the charging station alliance, charging stations, and charging stations. However, the embodiments of the present invention are not limited to this, and other information can also be collected, such as government policy adjustment information, map update information provided by electronic map providers, etc.

The information related to electric vehicles and charging stations can be divided into public information and private information. Public information is shared in real-time through communication platforms such as cellular networks or vehicular networks (IOVs). Private information can only be accessed by its respective owners. The communication platform itself does not generate new data but embedded online map services can provide derivative results based on public information.

Regarding information on electric vehicles, let I represents a collection of electric vehicles, then a certain electric vehicle i∈I, the public information comprises real-time location, State of Charge (SOC), target charging status, battery capacity, and time limits. Real time location and charging status are automatically captured by the communication platform, while users provide the remaining data; if electric vehicle users refuse or fail to provide this information, default values can be used instead. Private information comprises a time sensitivity coefficient, which represents the importance of travel time in charging decisions (which will be described in detail later).

Regarding information about charging stations, let J represents a collection of charging stations, then a certain charging station j∈J, the public information comprises the location of charging stations, real-time charging prices, and expected waiting times. The private information of charging stations comprises the distribution of perceived time sensitivity coefficients (which will be described in detail later).

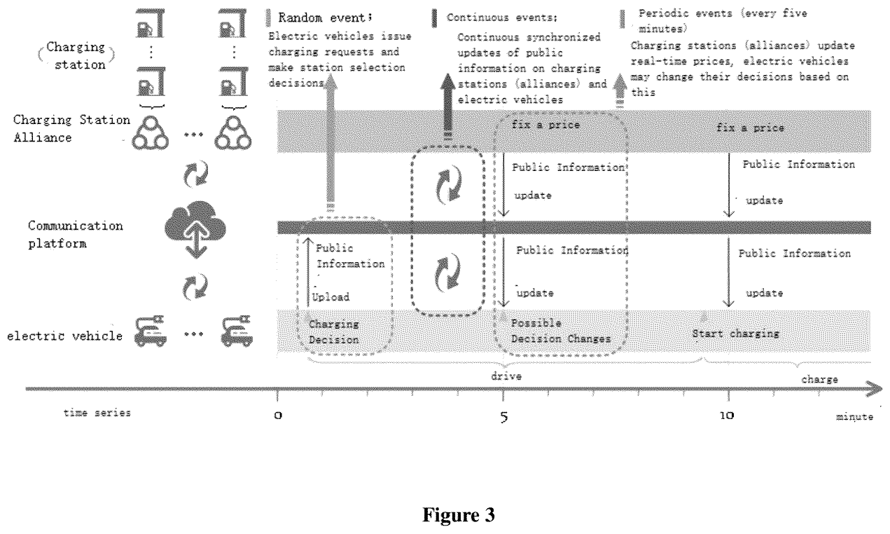

FIG. 3 is a schematic diagram showing the time series and information exchange relationship in the charging station alliance management system for electric vehicle charging according to an embodiment of the present invention.

As shown in FIG. 3, the charging station regularly makes pricing decisions based on existing charging requests and broadcasts real-time charging prices for the next stage. Electric vehicle users can make charging requests at any random time and simultaneously broadcast public information. At the same time, electric vehicle users browse information about nearby charging stations, make decisions, and then drive to the target station or postpone charging. Before connecting an electric vehicle to a charging station, users can still change their decision. Thus, the information collected by the information collection module can be interactively utilized between the electric vehicle and the charging station through the communication module described below.

The information processing module is connected to the information collection module for communication, receiving and processing various information collected by the information collection module, and providing feedback to the administrator for improvement and processing of incomplete or unprocessed information. The information processing module sets processing conditions based on the actual needs of the charging station alliance management system for electric vehicle charging according to the embodiments of the present invention, and the processed information is suitable for the usage needs, storage, and continuous learning and optimization of the charging station alliance management system for electric vehicle charging according to the embodiments of the present invention.

The storage module is connected to the information processing module for communication, and stores various information processed by the information processing module. The storage module can be a memory, such as non-volatile memory, volatile memory, flash memory, magnetic memory, phase change memory, or it can be cloud storage.

The pricing decision module is connected to the information processing module and/or storage module for communication, implementing charging pricing for each charging station, supporting the charging station to charge and charge according to pricing, and transmitting the pricing results to the storage module for storage.

In the pricing decision module, establish an electric vehicle decision model (i.e. user decision model) and a charging station alliance decision model, provide algorithms, set boundary conditions, and describe the electric vehicle decision model and the charging station alliance decision model as follows:

### Electric Vehicle Decision Model:

### Cost of Expenses

If charging in CS j, the cost of electric vehicle I is M_{i,j}, and it is the product of charging price and charging capacity:

$${M}_{i , j} = {p}_{j} {E}_{i , j} \qquad ( 1 )$$

wherein pⱼ is the charging price of charging station j at the time of decision-making; and E_{i,j} is the charging capacity of electric vehicle i. E_{i,j} is expressed as

$${E}_{i , j} = min \{ {E}_{i}^{target} , {E}_{i , j}^{max} \} , \qquad ( 2 )$$

$$wherein {E}_{i}^{target}$$

is the amount of electricity required to achieve the target SOC, and

$${E}_{i , j}^{max}$$

is the maximum rechargeable capacity at charging station j:

$${E}_{i}^{target} = ( {Soc}_{i}^{target} - {Soc}_{i} ) {C}_{i} , \qquad ( 3 )$$

$${E}_{i , j}^{max} = {q}_{i , j}^{ch , max} {t}_{i}^{limit} , \qquad ( 4 )$$

$$wherein {Soc}_{i}^{target}$$

indicates the target SOC, set by the electric vehicle user, with a default value of 0.8; Socᵢ is real-time SOC, Cᵢ is the battery capacity,

$${t}_{i}^{limit}$$

is the charging time limit,

$${q}_{i , j}^{ch , max}$$

is the maximum charging power of electric vehicle i at charging station j.

### Time Cost

Time cost T_{i,j} is the sum of driving time and waiting time.

$${T}_{i , j}^{drive}$$

is refers to the driving time of electric vehicle i to charging station j,

$${T}_{j}^{wait}$$

is refers to the expected waiting time after arriving at charging station j, then

$${T}_{i , j} = {T}_{i , j}^{drive} + {T}_{j}^{wait} , \qquad ( 5 )$$

$$wherin {T}_{i , j}^{drive}$$

is accessing route planning services through the application programming interface (API) provided by online map service providers, it is easy to obtain as follows:

$${T}_{i , j}^{drive} = rp ( {x}_{EV , i} , {y}_{EV , i} , {x}_{CS , j} , {y}_{CS , i} ) , \qquad ( 6 )$$

wherein rp(□) is based on the current position of electric vehicle i(x_{EV,i}, y_{EV,i}) and the location of its target station (x_{CS,j}, y_{CS,j}), the function for calculating the required travel time is implemented by the route planning service of the online map service provider.

Estimated waiting time

$${T}_{i , j}^{drive}$$

is calculated and uploaded by charging station j. Assuming the number of electric vehicles queuing and charging at charging station j is

$${N}_{CS , j}^{EV , queue} and {N}_{CS , j}^{EV , ch}$$

The remaining required charging time is sorted in ascending order

$$( {t}_{1}^{remain , j} , , {t}_{{N}_{CS , j}^{EV , ch}}^{remain , j} ) , then {T}_{j}^{wait}$$

calculate by the following equation

$${T}_{j}^{wait} = \{ \begin{matrix}0 , & {N}_{CS , j}^{EV , ch} < {N}_{CS , j}^{EV , max} \\ {t}_{1 + {N}_{CS , j}^{EV , queue}}^{remain , j} , & {N}_{CS , j}^{EV , ch} = {N}_{CS , j}^{EV , max}\end{matrix} . \qquad ( 7 )$$

### Cost Integration

Decision makers with bounded rationality typically set a reference point to evaluate relative gains and losses and often exhibit a risk averse tendency. In addition, when the utility brought by an event is far from this reference point, the incremental change in perceived value will slow down. This mechanism makes the perceived value of decision-makers a non-linear function of the actual utility of the event. In general, if we represent the utility of an event as x, then the perceived value v (x) can be expressed as follows:

$$v ( x ) = \{ \begin{matrix}{( x - {x}_{0} )}^{α} , & x > {x}_{0} \\ - {λ ( {x}_{0} - x )}^{β} , & x \leq {x}_{0}\end{matrix} \qquad ( 8 )$$

wherein the parameters α, β (0<α, β<1) and λ (λ≥1) reflect users' decision-making preferences.

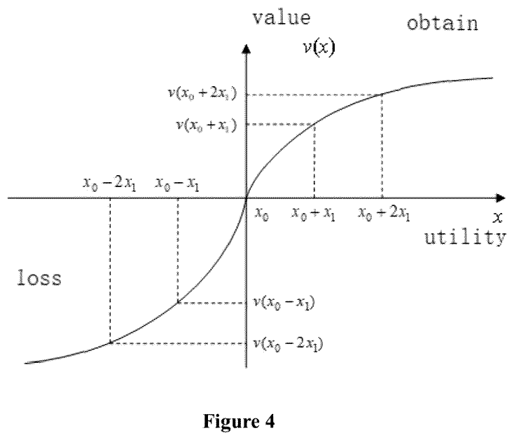

FIG. 4 shows the shape of the value function, where risk aversion is reflected as |v(x₀−x₁)|>|v(x₀+x₁)|, The marginal effect is reflected as v(x₀+2x₁)<2v(x₀+x₁).

In the context of the charging decision problem, charging stations are usually listed in the charging application in increasing distance order, which means that for electric vehicle users, the reference point is the charging station with the lowest time cost. Therefore, any additional time costs incurred by other charging stations are considered losses. When the cost of a charging station exceeds the cost of the reference point, the additional cost is considered a loss; on the contrary, if the cost of a charging station is low, the saved expenses are considered as revenue. Naturally, the value of time or cost is inversely correlated with the cost of time or cost. If used jₒⁱ to represent the reference charging station for electric vehicle i, the perception time value of charging station j is

$${v}_{i , j}^{T} = - λ ( - {T}_{i , {j}_{0}^{i}} + {T}_{i , j} ) . \qquad ( 9 )$$

$$Because ∀ j ∈ J , - {T}_{i , j} \leq - {T}_{i , {j}_{0}^{i}} .$$

The cost value of the charging station is

$${v}_{i , j}^{M} = \{ \begin{matrix}{( - {M}_{i , j} + {M}_{i , {j}_{0}^{i}} )}^{α} , & - {M}_{i , j} \geq {M}_{i , {j}_{0}^{i}} \\ - {λ ( {M}_{i , {j}_{0}^{i}} + {M}_{i , j} )}^{B} , & - {M}_{i , j} < {M}_{i , {j}_{0}^{i}}\end{matrix} \qquad ( 10 )$$

Through value integration, the value of time and cost can be integrated into a comprehensive value V_{i,j}, expression is

$${V}_{i , j} = {v}_{i , j}^{M} + {θ}_{i} {v}_{i , j}^{T} , \qquad ( 11 )$$

wherein 0ᵢ>0 is called the time sensitivity coefficient. The time sensitivity coefficient may vary among different users, as their financial situation and vehicle usage may also differ.

Generally speaking, electric vehicle users are more likely to choose charging stations with greater comprehensive value. But in extreme cases, electric vehicles believe that all charging stations have unacceptable prices, and it may just be that there are no available charging stations and delayed charging plans. This choice can also be equivalently regarded as “an additional virtual charging station code-1, using j₋₁ expressing”, Its cost of expenses M_{i,-1}, It can be regarded as a “normal” price (such as the average price at a month's time point), time cost T_{i,-1} calculated as follows:

$${T}_{i , - 1} = {T}_{i , {j}_{0}} + {t}_{i}^{limit} \frac{{Soc}_{safe}}{1 - {Soc}_{safe}} ( \frac{1}{{Soc}_{i}} - 1 ) , \qquad ( 12 )$$

wherein Soc_{safe} is the safety threshold for the charging process and is usually set at 0.1.

Apply the logit model to describe the probability selection process of electric vehicles for charging stations. For electric vehicle i, let J⁺ Represents the collection of all charging stations and virtual charging stations (i.e. J⁺=J∪{j₋₁}), The probability of selecting charging station j and V_{i,j} the natural index is directly proportional:

$${ρ}_{i , j} = \frac{exp ( {V}_{i , j} )}{{\sum }_{j ∈ {J}^{+}} exp ( {V}_{i , j} )} , j ∈ {J}^{+} . \qquad ( 13 )$$

In summary, the above equations (1)-(13) have established a decision model for electric vehicles.

### Decision Model of Charging Station Alliance:

The pricing of charging stations is a game between charging station alliances, with the goal of maximizing the total profit of the charging station alliance itself. The pricing decision of the Charging Station Alliance involves the prices of all subordinate charging stations. Assuming there is N^{CS} charging station is subordinate to N^{CSA} charging station alliance, of which the number of charging stations under alliance k is

$${N}_{CSA , k}^{CS} ,$$

the number of electric vehicles that have requested charging is N^{EV}. let J_{CSA,k} represents a collection of subordinate charging stations of the Charging Station Alliance k. Therefore, the decision variable of the charging station alliance k is the real-time charging price, denoted as {pⱼ,J∈J_{CSA,k}}. Once an electric vehicle starts charging, the charging price during the charging process will not change. The price adjustment cycle is 5 minutes.

The goal of Charging Station Alliance K is to maximize total profit:

$$max {R}_{CSA , k} = {R}_{CSA , k}^{change} + {R}_{CSA , k}^{DR} - {C}_{CSA , k}^{grid} . \qquad ( 14 )$$

Below, the charging revenue, demand response (DR) revenue, and grid electricity bill are described as follows.

Charging revenue is the mathematical expectation of the possible cost of electric vehicles, as shown in equation (15):

$${R}_{CSA , k}^{charge} = {\sum }_{i ∈ I} {\sum }_{j ∈ {J}_{CSA , k}} {E}_{i} {p}_{j} {σ}_{i , j} , \qquad ( 15 )$$

wherein σ_{i,j} is the probability of electric vehicle i choosing charging station j. It should be noted that in equation (13), σ_{i,j} is different from ρ_{i,j}, because from the perspective of the electric vehicle i to calculate ρ_{i,j}, θᵢ is considered as a constant, while from the perspective of charging station j, ρ_{i,j} is a function of a random parameter θ represented as ρ_{i,j}^{(θ)}. If we use f_{pdf}(□) to show θ as the probability density function, then σ_{i,j} is calculated by the following equation:

$${σ}_{i , j} = {\int }_{0}^{+ ∞} {ρ}_{i , j} ( θ ) {f}_{pdf} ( θ ) d θ . \qquad ( 16 )$$

Obviously, equation (16) is very complex because ρ_{i,j}^{(θ)} involves a large number of parameters, which makes it difficult to handle in analytical form. To ensure the practicality of the method, the distribution of can be represented by discrete typical values

$${Θ}^{value} = ( {θ}_{1}^{dis} , {θ}_{2}^{dis} , … , {θ}_{Z}^{dis} ) ,$$

and the corresponding probabilities of these typical values

$${Θ}^{prob} = ( {\int }_{0}^{{θ}_{1}^{dis}} {f}_{pdf} ( θ ) d θ , {\int }_{{θ}_{1}^{dis}}^{{θ}_{2}^{dis}} {f}_{pdf} ( θ ) d θ , … , {\int }_{{θ}_{Z - 1}^{dis}}^{∞} {f}_{pdf} ( θ ) d θ )$$

roughly describe it.

Therefore, σ_{i,j} can be approximated as

$${σ}_{i , j} = {\sum }_{𝓏 = 1}^{Z} {ρ}_{i , j} ( {Θ}^{value} ( 𝓏 ) ) \cdot {Θ}^{prob} ( 𝓏 ) . \qquad ( 17 )$$

The larger the z, the more precise (17) will be, and correspondingly, more computing resources will be required.

Demand response (DR) is widely used in the demand management by temporarily reducing load, among which

$${p}_{0}^{DR}$$

is the electricity price during the DR period.

In incentive based demand response, electricity users can receive compensation by committing to reducing load during specific periods of time. However, if users fail to fulfill their commitments, they will face punishment. A typical example is the Basic Interruption Procedure (BIP) implemented by Pacific Oil and Power Company in California, USA. Under this program, users can receive a monthly reward of 8-9 $/kw. During the demand response period, for any additional load exceeding the pre-selected demand level (fixed service level, firm service level, FIL), they will be fined $6/kw. Users will receive a notification of demand response events 30 minutes in advance. Due to the fact that the monthly rewards remain unchanged regardless of whether the specified load reduction requirements are met, the main focus during the pricing phase is on penalty fees. Therefore, the demand response revenue of Charging Station Alliance K can be expressed as:

$${R}_{CSA , {k}^{=}}^{DR} {r}_{CSA , k}^{DR , PRE} - ω max \{ {q}_{CSA , k}^{max , DR} - {q}_{CSA , k}^{FIL} , 0 \} , wherein {r}_{CSA , k}^{DR , PRE} \qquad ( 18 )$$

is a prepaid DR incentive that remains unchanged during the pricing phase, ω is the DR penalty price (PP),

$${q}_{CSA , k}^{max , DR}$$

is the maximum total load of the subordinate charging stations during DR period, and

$${q}_{CSA , k}^{FIL}$$

is FIL for charging station k, let t₀ indicate the current time point, if electric vehicle i makes a charging request and will be charged at charging station j, then electric vehicle i will be charged at any time point at charging station j t∈[t₀, +28], tool, the charging capacity can be expressed as (19):

$${q}_{EV , i} ( t ) = \{ \begin{matrix}0 , & {t}_{0} \leq t < {t}_{0} + {T}_{i , j} \\ {q}_{i , j}^{ch , max} & {t}_{0} + {T}_{ι j} \leq t \leq {t}_{0} + {T}_{i , j} + {E}_{i , j} / {q}_{i , j}^{ch , max} \\ 0 , & t > {t}_{0} + {T}_{i , j} + {E}_{i , j} / {q}_{i , j}^{ch , max}\end{matrix} , \qquad ( 19 )$$

let Îⱼ expressed in t₀ If the collection of electric vehicles is charged at charging station j, then the electric vehicle î∈Îⱼ at any point in time t∈[t₀, +∞] the charging power can be expressed as equation (20):

$${q}_{EV , \hat{i}} ( t ) = \{ \begin{matrix}{q}_{\hat{i} , j}^{ch , max} & {t}_{0} \leq t \leq {t}_{0} + {t}_{\hat{i}}^{remain , j} \\ 0 , & t > {t}_{0} + {t}_{\hat{i}}^{remain , j}\end{matrix} , wherein {t}_{\hat{i}}^{remain , j} \qquad ( 20 )$$

is the remaining charging time of electric vehicles at charging station j.

Therefore,

$${q}_{CSA , k}^{max , DR}$$

can be calculated by the following formula

$${q}_{CSA , k}^{max , DR} = {max}_{t} \{ {\sum }_{j ∈ J} [ {\sum }_{i ∈ I} {q}_{EV , i} ( t ) {σ}_{i , j} + {\sum }_{\hat{i} ∈ {\hat{I}}_{j}} {q}_{EV , \hat{i}} ( t ) ] \} . \qquad ( 21 )$$

The grid electricity fee is the cost of purchasing electricity from the grid by the charging station alliance, determined by real-time electricity prices:

$${C}_{CSA . k}^{grid} = {\sum }_{i ∈ I} {\sum }_{j ∈ {J}_{CSA , k}} {E}_{i} {p}_{0} {σ}_{i , j} , \qquad ( 22 )$$

wherein p₀ is the electricity price of the power grid.

Price boundary constraint is as follows:

$${P}_{0} \leq {P}_{j} \leq {P}_{max} , ∀ j ∈ {J}_{CSA , k} , \qquad ( 23 )$$

wherein pₘₐₓ is the upper limit of charging prices, usually determined by relevant policies. In the pricing decision module according to the embodiments of the present invention, the specific pricing decision fully considers the response mechanism of electric vehicles to charging prices, achieving the maximization of profits for charging stations in the form of an alliance. According to the embodiments of the present invention, the pricing decision module comprises modeling the price factors that affect the charging station alliance, providing a dynamic pricing strategy, and using a two-stage evolutionary game to determine the optimal pricing decision of the charging station alliance in the expanding action space. According to the embodiments of the present invention, factors affecting the price of charging stations may comprise grid electricity prices, site costs, depreciation of charging piles, charging rates and utilization rates, competition in the same industry, and customer satisfaction. The charging pricing of all charging stations in any charging station belonging to the Charging Station Alliance can be the same or different.

The learning and optimization module is connected to the storage module for communication, continuously learning various information about users, members of the charging station alliance, charging stations, and charging piles, as well as the pricing results of the pricing decision module. Based on feedback from users, members of the charging station alliance, charging stations, and charging piles, various suggestions are made to optimize the pricing and services of each member of the charging station alliance, their charging stations, and charging piles in the system. In addition to the pricing decisions discussed above, the learning and optimization module will also progressively learn and optimize the customer service interaction module and the charging station layout optimization module described below, thereby achieving continuous optimization of the charging station alliance management system for electric vehicle charging according to the embodiments of the present invention.

The communication module is connected to the storage module for communication, and a charging station alliance management system is established for real-time communication with electronic map providers, users, members of the charging station alliance, charging stations, and charging piles. The electronic map provided by the electronic map provider is obtained, and each charging station is loaded on the electronic map to form a charging station map that comprises each charging station in the charging station alliance.

The customer service interaction module displays a charging station map on the client, which comprises the distribution of charging stations and the geographic coordinates of each charging station, the distance from the user to the charging station, charging price information, and notification information related to electric vehicle charging. This establishes interactive communication between the user and their selected charging station.

According to the embodiments of the present invention, the customer service interaction module may comprise text interaction and voice interaction. The customer service interaction module comprises a robot for on duty interaction, which greets and inquires about customer needs, and answers questions raised by customers. Before the user charges, the customer service interaction module can explain the expected waiting time to the user based on the current queue situation, and provide information on the supporting facilities of the charging station (such as convenience stores) to assist the user; during the charging process, the customer service interaction module can prompt the user of the remaining charging time based on the charging progress, and suggest that the user leave in a timely manner to improve the utilization rate of the charging station service.

According to the embodiments of the present invention, the charging station alliance management system for electric vehicle charging may further comprise a charging status monitoring module for monitoring and reporting the queuing status of each charging station. The information processing module predicts the possible queuing time of the user based on the queuing status information provided by the charging status monitoring module and displays it on the client.

According to the embodiments of the present invention, the charging station alliance management system for electric vehicle charging may further comprise a surrounding road monitoring module, which communicates with the road monitoring of the electronic map to obtain the road conditions and vehicle congestion levels around each charging station, and reports the average driving speed of a certain road section and the time required for the customer to arrive at the charging station according to the customer's request. According to the embodiments of the present invention, the surrounding road monitoring module may have a driving route comparison function, providing the mileage and time of different driving routes for users to decide on their own.

According to the embodiments of the present invention, the charging station alliance management system for electric vehicle charging may further comprise a cost budgeting module, which calculates and provides the cost of this electric vehicle charging based on the information provided by the user on the interactive communication module, comprising travel costs, waiting costs such as queuing, charging time costs, charging electricity costs, and charging site usage costs.

According to the embodiments of the present invention, the charging station alliance management system for electric vehicle charging may further comprise an opinion feedback module, which is connected in communication with the charging station alliance management system and transmits the customer feedback and suggestions obtained by the opinion feedback module to the information collection module of the charging station alliance management system. After processing by the information processing module, they are stored in the storage module of the charging station alliance management system and further optimized by the learning and optimization module.

According to the embodiments of the present invention, when the charging status monitoring module detects that the number of electric vehicles waiting in line for charging reaches a predetermined threshold, it provides the user with the actual situation of waiting in line and prompts the user about the location and charging pricing of nearby charging stations belonging to the charging station alliance, so that the user can choose to charge off peak or at nearby charging stations according to their own decision.

According to the embodiments of the present invention, the charging station layout optimization module discusses and concludes on the optimization suggestions provided by the communication module and provides optimization solutions for the addition or removal of members of the charging station alliance, the addition or removal of charging stations, the addition or removal of charging piles, the performance requirements and upgrading of charging piles. The performance requirements and optimization plans for upgrading and replacing charging stations comprise summarizing users' preferences for charging stations based on their historical order data under different charging rates, charging times, and charging environments, and forming requirements for charging station charging rates, charging times, and charging environments; and the optimization scheme provided by the layout optimization module comprises the charging station layout scheme obtained based on the spatiotemporal distribution characteristics of historical orders and the analysis of charging demand hotspots.

According to the embodiments of the present invention, the charging station alliance management system for electric vehicle charging may further comprise a charging status monitoring module for monitoring and reporting the queuing status of each charging station. The information processing module predicts the possible queuing time of the user based on the queuing status information provided by the charging status monitoring module and displays it on the client.

According to the embodiments of the present invention, the charging station alliance management system for electric vehicle charging may further comprise a surrounding road monitoring module, which communicates with the road monitoring of the electronic map to obtain the road conditions and vehicle congestion levels around each charging station, and reports the average driving speed of a certain road section and the time required for the customer to arrive at the charging station according to the customer's request.

Compared with existing technologies, the charging station alliance management system for electric vehicle charging according to the embodiments of the present invention can achieve at least the following beneficial effects:
1. Against the backdrop of the rapid development of the electric vehicle industry, the number of electric vehicles in the market is rapidly increasing. Although each electric vehicle is equipped with a charging station, the problem of charging electric vehicles during operation is particularly prominent. According to the embodiments of the present invention, the charging station alliance management system for electric vehicle charging proposes a complete technical solution to solve the supply-demand contradiction of charging stations and improve the charging service of electric vehicles.
2. Established a decision model for electric vehicles and charging stations, integrating the uncertainty caused by information asymmetry between electric vehicles and charging stations and the limited rationality of electric vehicle users. The standardized management of charging stations and reasonable pricing of charging are urgent problems that need to be solved in the market. In order to solve the pricing decision model, evolutionary game theory is used to describe the dynamic pricing game between charging station alliances, and the equilibrium provides the optimal pricing strategy.
3. The charging station alliance management system for electric vehicle charging according to the embodiments of the present invention can be used for current small-scale charging station alliances, as well as for future large-scale charging station alliances. The information collected through the information module from both the supply and demand ends will continue to increase, and one of the important means to solve the supply-demand imbalance is to reasonably layout the charging stations. With the continuous development and growth of the charging station alliance, under the incentive of negotiation and co construction, and within the framework of the charging station alliance management system for electric vehicle charging according to the embodiments of the present invention, the charging stations can be reasonably laid out through inter alliance interaction and negotiation.

The above description is only an exemplary description of embodiments of the present invention and is not intended to limit the scope of protection of the present invention, which is determined by the appended claims.

We claim:

1. A charging station layout optimization system of a charging station alliance, comprising:
an information acquisition module configured for collecting information comprising a user electric vehicle information, a user charging request information, an information from charging station alliance members, a charging station information, and a charging pile information;
an information processing module communicatively connected with the information acquisition module and configured for receiving and processing the information collected by the information acquisition module and feedbacking an incomplete or unmanageable information to an administrator to complete and process;
a memory storage module communicatively connected with the information processing module and configured for storing the information fully processed by the information processing module;
a pricing decision module communicatively connected with the information processing module, the memory storage module, or both, and configured for providing a charging price for each charging pile, technically supporting the charging pile for implementing charging and feeing according to the price, and transmitting the pricing results to the memory storage module for storing;
a learning and optimizing module communicatively connected with the memory storage module and configured for continuously learning various information from the users, the charging station alliance members, the charging stations, and the charging piles, learning the pricing results of the pricing decision module, and optimizing pricing and service of each charging station alliance member, and the charging stations and the charging piles thereof in the system according to opinions and suggestions feedbacked from users, the charging station alliance members, the charging stations, and the charging piles;
a communication module communicatively connected with the memory storage module and configured for establishing an among-charging-station-alliance-members interactive module among the members of the electric vehicle charging alliance, and researching according to user demand, a variation of the electric vehicle battery performance, and an optimized suggestion provided by the learning and optimizing module; and
a charging station layout optimization module configured for providing an optimized scheme for increasing or decreasing the charging station alliance members, increasing or decreasing the charging stations, increasing or decreasing the charging piles, a performance requirement and upgrading of the charging piles according to the researching results of the optimized suggestion provided by the communication module,
wherein the optimized scheme provided by the performance requirement and upgrading of the charging piles comprises the requirements of a charging rate, a charging time, and a charging environment, and
wherein the optimized scheme provided by the layout optimization module comprises a judging report of a charging station layout scheme requested by the charging station alliance members.

2. The charging station layout optimization system of the charging station alliance as claimed in the claim 1, further comprising
a charging condition monitoring module configured to monitor and report a queueing condition of each charging station,
wherein the information processing module forecasts a possible queueing time to the users and displays on the client-side according to the queueing condition information provided by the charging monitoring module.

3. The charging station layout optimization system of the charging station alliance as claimed in the claim 1, further comprising
a peripheral road monitoring module,
wherein the peripheral road monitoring module communicates with a road monitoring of an electronic map, gets road conditions and a traffic congestion level around each charging station, and reports an average driving speed of a certain road section and a user taken time to reach the charging station according to the client request.

4. The charging station layout optimization system of the charging station alliance as claimed in the claim 1, further comprising
a cost budget module configured to calculate and provide a cost of the present electric vehicle charging, comprising a driving cost, a queueing cost, a charging time cost, a charging expense cost and a charging place using cost, according to the information provided by the users on the interactive communication module.

5. The charging station layout optimization system of the charging station alliance as claimed in the claim 1, further comprising
a feedback module,
wherein the feedback module is communicatively connected with the charging station alliance management system and transmits the customer feedback opinions and suggestions obtained by the feedback module to the information acquisition module of the charging station layout optimization system, which is stored into the memory storage module after processed by the information processing module, and is further optimized by the learning and optimizing module.

6. The charging station layout optimization system of the charging station alliance as claimed in the claim 1, wherein the memory storage module comprises memory device or cloud storage.

7. The charging station layout optimization system of the charging station alliance as claimed in the claim 1, wherein the pricing decision module comprises an optimal pricing decision of the charging station alliance, in which takes the charging station alliance as an object, models based on price factors influencing the charging station, provides dynamic pricing strategies, and determines the action space by adopting a two-stage evolutionary game.

8. The charging station layout optimization system of the charging station alliance as claimed in the claim 7, wherein the price factors influencing the charging station comprise power grid price, site cost, depreciation of charging piles, charging rate and utilization rate, same industry competition, customer satisfaction level.

9. The charging station layout optimization system of the charging station alliance as claimed in the claim 7, wherein the charging prices for all the charging piles in any one of the charging stations which belong to the charging station alliance are same or different.

10. The charging station layout optimization system of the charging station alliance as claimed in the claim 1, further comprising
an among-alliance-members interactive module established among the charging station alliance members,
wherein the among-alliance-members interactive module comprises a character interaction, a voice interaction and a video conference.

11. The charging station layout optimization system of the charging station alliance as claimed in the claim 10, wherein the charging station alliance members make a decision to the optimized scheme by the among-alliance-members interactive module, after the layout optimization module provides the optimized scheme for increasing or decreasing the charging station alliance members, increasing or decreasing the charging stations, increasing or decreasing the charging piles, the performance requirement and upgrading of the charging piles.

12. The charging station layout optimization system of the charging station alliance as claimed in the claim 10, wherein the peripheral road monitoring module comprises a function of traffic condition statistic of the peripheral road, and the layout optimization module takes a result of the traffic condition statistic of a plurality of the adjacent charging stations counted by the peripheral road monitoring module as one of the optimized parameters, in order to decide the optimized scheme of the increasing and decreasing the charging station alliance members, increasing or decreasing the charging stations, increasing or decreasing the charging piles, the performance requirement and upgrading of the charging piles.

13. The charging station layout optimization system of the charging station alliance as claimed in the claim 2, wherein when the charging condition monitoring module monitors that the numbers of the electric vehicles waiting for charging in line reach a predetermined threshold, the layout optimization module takes the number of the electric vehicles waiting for charging in line which monitored by the charging condition monitoring module as one of the optimized parameters, in order to decide the optimized scheme for increasing or decreasing the charging station alliance members, increasing or decreasing the charging stations, increasing for decreasing the charging piles, the performance requirement and upgrading of the charging piles.

14. A charging station alliance management system for charging electric vehicles, comprising:
an information acquisition module configured for collecting information comprising a user electric vehicle information, a user charging request information, an information from charging station alliance members, a charging station information, a charging pile information;
an information processing module communicatively connected with the information acquisition module and configured for receiving and processing the information collected by the information acquisition module, and feedbacking an incomplete or unmanageable information to an administrator to complete and process;
a memory storage module communicatively connected with the information processing module and configured for storing the information fully processed by the information processing module;
a pricing decision module communicatively connected with the information processing module, the memory storage module, or both, and configured for providing a charging price for each charging pile, technically supporting the charging pile for implementing charging and feeing according to the charging price, and transmitting pricing results to the memory storage module for storage;
a learning and optimizing module communicatively connected with the memory storage module and configured for continuously learning information from users, the charging station alliance members, the charging stations, and the charging piles, learning the pricing results of the pricing decision module, and optimizing the pricing and the service of each charging station alliance member, and the charging stations and the charging piles thereof in the system according to opinions and suggestions feedbacked from the users, the charging station alliance members, the charging stations, and the charging piles;
a communication module communicatively connected with the memory storage module and configured for establishing a real-time communication between the charging station alliance management system and electronic map providers, the users, the charging station alliance members, the charging stations and the charging piles, getting an electronic map provided by the electronic map providers, and loading each charging station on the electronic map to form a charging station map containing each charging station in the charging station alliance;
a customer service interaction module displaying the charging station map on a client-side, wherein the charging station map comprises a distribution diagram of the charging stations and a geographic coordinate information of each charging station, a route from users to the charging station, a charging price information, and a notifying information related to charge the electric vehicles, thus establishing an interactive communication between the user and its selected charging station and
a charging station layout optimization module providing an optimized scheme directing at increasing and decreasing the charging station alliance members, increasing or decreasing the charging stations, increasing or decreasing the charging piles, a performance requirement and upgrading of the charging piles according to the researching results of the optimized suggestion provided by the communication module,
wherein the optimized scheme provided by the performance requirement and upgrading of the charging piles comprises the requirements of a charging rate, a charging time, and a charging environment, and
wherein the optimized scheme provided by the layout optimization module comprises a judging report of a charging station layout scheme requested by the charging station alliance members.

15. A charging station alliance management system for charging electric vehicles, comprising the charging station layout optimization system of the charging station alliance as claimed in the claim 1.
